(19) United States
(12) Patent Application Publication
(10) Pub. No.: US 2008/0246571 A1
(43) Pub. Date: Oct. 9, 2008

(54) Magnetic Core, Magnetic Arrangement and Method for Producing the Magnetic Core

(76) Inventor: Wulf Guenther, Maintal (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/067,849

(22) PCT Filed: Jul. 21, 2006
(86) PCT No.: PCT/EP2006/007186

§ 371 Date: Jun. 4, 2008

(30) Foreign Application Priority Data
Sep. 26, 2005 (DE) 10 2005 045 911.0

(51) Int. Cl. H01F 3/04; H01F 3/00

(52) U.S. Cl. 335/297; 29/609

(57) ABSTRACT

A magnetic core has at least two layers (3, 4) of a magnetic material, each layer having a longitudinal axis (L1, L2) and a magnetic preferential orientation (anisotropic direction) (k) at least approximately perpendicular to the longitudinal axis. In order to minimize the coercitive field strength and remanence and to achieve the highest possible quality it is provided that the different layers are oriented, independently of the orientation of the longitudinal axes, in such a way that the angles between the anisotropic directions (k) of directly adjacent layers are as minimal as possible.

### CROSS-REFERENCE TO RELATED APPLICATIONS

This application is a U.S. national stage application of International Application No. PCT/EP2006/007186 filed Jul. 21, 2006, which designates the United States of America, and claims priority to German application number 10 2005 045 911.0 filed Sep. 26, 2005, the contents of which are hereby incorporated by reference in their entirety.

### TECHNICAL FIELD

The invention relates to the construction and manufacturing procedures of open magnetic cores, in particular magnetic rod cores.

### BACKGROUND

Besides ferrite cores, laminated cores consisting of thin layers of amorphous or nanocrystalline metallic magnetic material have proven to be very powerful magnetic cores, in particular for use in low frequencies.

Said magnetic cores are used for example in the field of RFID for theft protection, recognition and identification systems as well as wireless energy and information transfer. Corresponding working frequencies can be within the range of 20 to 150 kHz or around 13.5 MHz. The corresponding magnetic cores are mass produced and subject to extreme price erosion.

Special requirements arise if the permitted eddy current losses are small and the quality requirements of the cores are high. In laminated cores, corresponding qualities can only be achieved with extremely thin layers (smaller than 15 μm); based on the state of the art, they are preferably separated by electrically isolated intermediate layers.

To achieve the desired properties of the magnetic core, the magnetic B (H) dependency (constant differential effective permeability dB/dH across the whole H-range) needs to be as linear as possible and the coercive field strength or retentivity minimal. Thus, losses are minimized and the quality maximized. B indicates induction, H the magnetic field.

To realize the intended hysteresis loop, namely with a hysteresis as small as possible and a linear B (H) dependency, it is optimal if the crystalline magnetic ranges of a single layer (elementary magnets) and their magnetization are positioned perpendicular to the orientation of the magnetic field which is later created for example by means of a coil and is ideally facing the average orientation of the longitudinal axes of the layers. In this case, the use of an outer magnetic field results in the deflection of the elementary magnets with an almost linear dependence on the magnetic field strength. When the orientation of the magnetic field is changed, the elementary magnets turn back.

### SUMMARY

The present invention relates to a magnetic core with at least two layers of magnetic material where each layer comprises a separate longitudinal axis of the layer as well as a preferred magnetic orientation (anisotropic direction) which is at least almost perpendicular to the longitudinal axis of the layer. Commonly, with conventional orientation, the longitudinal axis is an axis of symmetry identical or almost parallel with the manufacturing orientation (e.g. pouring orientation) of the tape and the magnetization orientation. The anisotropic direction described above is also known as transverse anisotropy.

A magnetic core of the type described above can be created, which combines superior quality with high permeability while using regular layer thicknesses and which can be produced at low cost. According to an embodiment, a magnetic core may comprise at least two layers of a magnetic material, wherein each layer comprises a separate longitudinal axis of the layer as well as a preferred magnetic orientation (anisotropic direction) which is at least almost perpendicular to the longitudinal axis of the layer, and wherein the different layers are oriented in such a way that the angles between the anisotropic direction of directly adjacent layers are as small as possible, irrespective of the orientation of the longitudinal axes of the layers.

According to a further embodiment, the angles between the anisotropic directions of adjacent layers may be smaller than 10°. According to a further embodiment, the angle may be smaller than 4°. According to a further embodiment, the individual layers with respect to their position during the manufacturing step during which the preferred magnetic orientation is created, may be positioned on top of one another untwisted. According to a further embodiment, the layers may be manufactured by means of rapid solidification technology and that, if the side facing the heat sink is referred to as bottom side and the opposite site is referred to as top side, the top side of each layer is adjacent to the bottom side of the respective adjacent layer. According to a further embodiment, the roughness of the layers in the place where several layers touch one another may be less than 0.5 μm. According to a further embodiment, the roughness of the layers may be less than 0.3 μm. According to a further embodiment, the distance between adjacent layers may be less than 20 μm. According to a further embodiment, the distance between adjacent layers can be less than 10 μm. According to a further embodiment, the layers may consist of a material with a relative permeability between 500 and 20,000. According to a further embodiment, the relative permeability may be between 1,000 and 10,000. According to a further embodiment, the quality may be greater than 20 with a frequency of 125 kHz. According to a further embodiment, the layers may consist of an amorphous or nanocrystalline magnetic material. According to a further embodiment, the adjacent layers can be separated by intermediate layers made of non-magnetic and/or electrically isolating material. According to a further embodiment,

According to a further embodiment, a magnetic arrangement comprising such a magnetic core as described above may further comprise a coil surrounding the magnetic core, wherein the coil is essentially parallel to a longitudinal axis of the magnetic core, and wherein the longitudinal axis is determined by averaging the individual longitudinal axes of the layers.

According to another embodiment, a method for the manufacture of a magnetic core, may comprise the step of: during the manufacturing process of individual layers of a magnetic material, wherein each layer comprises a separate longitudinal axis of the layer as well as a preferred magnetic orientation (anisotropic direction) which is at least almost perpendicular to the longitudinal axis of the layer, and wherein the different layers are oriented in such a way that the angles between the anisotropic direction of directly adjacent layers are as small as possible, irrespective of the orientation of the longitudinal axes of the layers, their position is recorded relative to one another and is taken into account when they are stacked in such a way that the individual layers are stacked untwisted compared to their position relative to one another during the manufacturing process. According to yet another embodiment, a method for the manufacture of a magnetic core as described above, may comprise the step of: the preferred magnetic orientations of adjacent layers are oriented parallel to one another as much as possible while the layers are stacked and that individual or several of the layers are subsequently trimmed in such a way that a massive stack develops. According to a further embodiment, the individual layers may be manufactured as segments of a continuously produced tape which is equipped with a preferred magnetic orientation and then divided. According to a further embodiment, the layers may be first manufactured and the preferred magnetic orientation may be applied when they are stacked. According to a further embodiment, the preferred magnetic orientation may be adjusted by means of heat treatment in a magnetic field. According to a further embodiment, a mechanical tensile force may be applied perpendicular to the preferred magnetic orientation within the scope of the generation of the latter. According to a further embodiment, in the method an anisotropy may be adjusted essentially perpendicular to the running direction of the tape. According to a further embodiment, in the method an anisotropy may be adjusted essentially perpendicular to the running direction of the tape.

### BRIEF DESCRIPTION OF THE DRAWINGS

Below, the invention is shown in an illustration based on an exemplary embodiment, followed by a description. In it

FIG. 1 shows a magnetic core according to an embodiment with a coil,

FIG. 2 shows a diagram of a layer with an anisotropic direction k, which deviates from the perpendicular to the longitudinal axis of the layer,

FIG. 3 shows several layers with the longitudinal axes deviating from the longitudinal axis of the coil,

FIG. 4 shows two layers with the anisotropic directions twisted against each other in the field of the coil,

FIG. 5 shows two layers with the longitudinal axes arranged parallel to one another and parallel to the longitudinal axis of the coil, while their anisotropic directions differ by the angle δ=2α,

FIG. 6 shows several hysteresis loops of different core constellations for comparison.

### DETAILED DESCRIPTION

According to various embodiments, the different layers may be arranged in such a way that the angles between anisotropic directions of directly adjacent layers are as minimal as possible, irrespective of the orientation of the longitudinal axes of the layers.

It was determined that the desired material properties of the magnetic core for magnetization in a parallel direction with the longitudinal axes of the layers can be achieved if the anisotropic direction of each of the layers is diagonal to the longitudinal axis and if the anisotropic directions of adjacent layers differ as little as possible from one another, in particular less than 10°, or better less than 4°. Deviations in the directions of longitudinal axes of layers of adjacent layers or deviations in the respective longitudinal axis of the layer from the orthogonal to the anisotropic direction are less influential.

Contrary to the current opinion, adjacent layers affect one another due to static magnetic effects to such an extent that the as accurate as possible concordance of the orientation of the anisotropic directions of adjacent layers has the greatest effect on the magnetic core quality defined above. Therefore, adjacent layers are positioned in such a way that the anisotropic directions are virtually parallel with one another.

Other geometric parameters of the individual layers are only taken into account in a secondary step.

If the individual layers are manufactured for example by means of rapid solidification technology in the form of a continuous tape, which is continuously magnetized and later divided, care needs to be taken that the anisotropic direction of the tape along its length changes as little as possible on the one hand and that the individual layers created as a result of the division of the manufactured tape are not twisted during the manufacturing process so that they will be stacked the same way the like charges were oriented. If the anisotropic direction of the individual layers deviates from the perpendicular to the longitudinal axis of the layer, said stacking at least achieves that the deviation in the orientation of anisotropy of the adjacent layers is similar and the difference of the angles between adjacent layers is not very large. The opposite would be true if two layers against each other would be turned 180° compared to their position during the manufacturing process before they were stacked on top of one another. In this case, the deviations in the anisotropic direction compared to the perpendicular to the longitudinal axis would be added together and the quality of the resulting magnetic core would dramatically deteriorate.

It goes without saying that the corresponding careful orientation of the anisotropic directions needs to be taken into account when the individual layers are manufactured in a different way. If a known distribution of anisotropic directions applies to a number of layers, the layers can be arranged in such a way with the selection of the stacking order that the sum of the angles between adjacent layers of the respective anisotropic directions is minimized.

The magnetostatic nature of the interaction between adjacent layers requires that a particularly major disruption takes place when the surfaces of adjacent layers facing one another are very rough. This effect may be explained by the fact that because of the corresponding roughness and the associated disrupted magnetic structure of the surface many magnetic field lines exit the structure of the individual layer and enter an adjacent layer, causing the magnetic properties of adjacent layers to influence one another strongly. It is therefore beneficial if the roughness of the overall surface areas is smaller than 0.5 μm, better yet smaller than 0.3 μm. This is particularly important if the adjacent layers are very close to one another, for example with a distance smaller than 20 μm, in particular smaller than 10 μm.

The layers of the magnetic core preferably consist of metallic magnetic material with a relative permeability between 500 and 20,000, in particular between 1,000 and 10,000. As a result, the various embodiments enable the achievement of a quality exceeding 20 at frequencies of approximately 125 kHz. For this purpose, the layers may consist for example of amorphous or nanocrystalline magnetic material. The individual layers can preferably be separated from one another with intermediate layers consisting of non-magnetic and/or electrically isolating material. For example, a film with a thickness smaller than 20 μm can be used for this purpose.

According to another embodiment, in a magnetic arrangement with a magnetic core as described above, the magnetic arrangement is completed with a cylindrical coil surrounding the magnetic core. The cylindrical axis of the coil is arranged parallel to a longitudinal axis of the magnetic core which results from the averaging of the individual longitudinal axes of the layers or the axis of symmetry of the core.

Said design of the magnetic arrangement results in optimal parameters with respect to the magnetic characteristics, such as the quality and linearity of the hysteresis curve.

According to further embodiments, a manufacturing process can preferably be designed in such a way that the anisotropic direction of the tape fluctuates only slightly across short distances and that the individual layers are stacked on top of one another untwisted with respect to the position they were in during the manufacturing process at least when the preferable magnetic orientation was assigned. This results in a minimal difference of the angles between the anisotropic directions of adjacent layers.

In addition, said orientation of the individual layers may require the corresponding layers to be stacked at different positions of the angles of the longitudinal axes of the layers. In this case, the individual layers may be trimmed accordingly to form a massive, for example a cuboid, magnetic core. The layers can be trimmed for example with lasers or with a high-pressure water jet.

The preferred magnetic orientation is impressed onto the individual layers either during the manufacture of a continuous tape consisting of magnetic material or after the individual layers have been separated accordingly. The preferred magnetic orientation is preferably achieved by means of heat treatment in a magnetic field. Additionally or exclusively, a longitudinal tensile force in the orientation of the longitudinal axes of the layers may be applied. According to various embodiments, the orientation of an average anisotropic direction compared to the longitudinal axis of the cylindrical coil is only of secondary significance with respect to a magnetic core or a corresponding magnet arrangement and that it is rather the deviation in the angles of the anisotropic directions of adjacent layers of the magnetic core which is relevant to the quality of the magnetic core.

Consequently, the exact orientation of the anisotropic directions is not as important as the uniformity of the orientation from layer to layer.

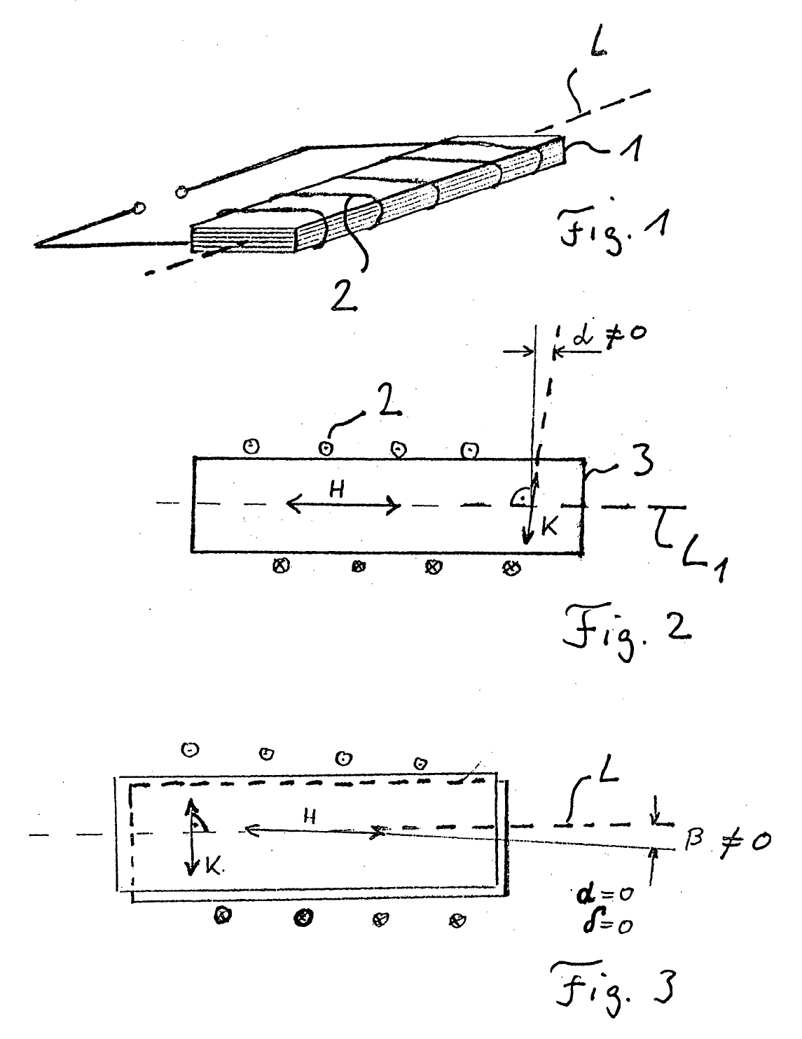

FIG. 1 shows a laminated core 1 in three-dimensional view comprising several layers of flat magnetic material, for example nanocrystalline or amorphous magnetic material with inserted spacers in the form of insulating film. The core 1 comprises the shape of a cuboid and is surrounded by a rolled up coil 2. In the illustrated arrangement, the longitudinal axis L of the core 1 is parallel to the longitudinal axis of the coil, hereinafter referred to as orientation of the field H.

FIG. 2 shows a single layer 3 with its anisotropic direction labeled k. In the shown arrangement, the longitudinal axis L1 of layer 3 is parallel with the cylindrical axis H of coil 2 which in turn corresponds to the field orientation of the coil.

The orientation of the anisotropy k deviates from the ideal status in which it is exactly perpendicular to the longitudinal axis L1 by an angle of α>0. This is the result of irregularities during the manufacturing process either because the core is subject to a corresponding field heat treatment as a stack and inhomogeneities occur during this process or because the layers are manufactured as a continuous tape, for example by means of rapid solidification technology with the continuous impressing of anisotropy by means of a field application, where irregularities may occur as well. Deviations α between 5 and 40° were measured with the known manufacturing procedures.

In principle, the mentioned irregularities should be minimized as much as possible; however, due to the required small manufacturing costs of a magnetic core according to an embodiment it is hardly possible to reduce the deviations of the angles of anisotropy to the extent that they are negligible.

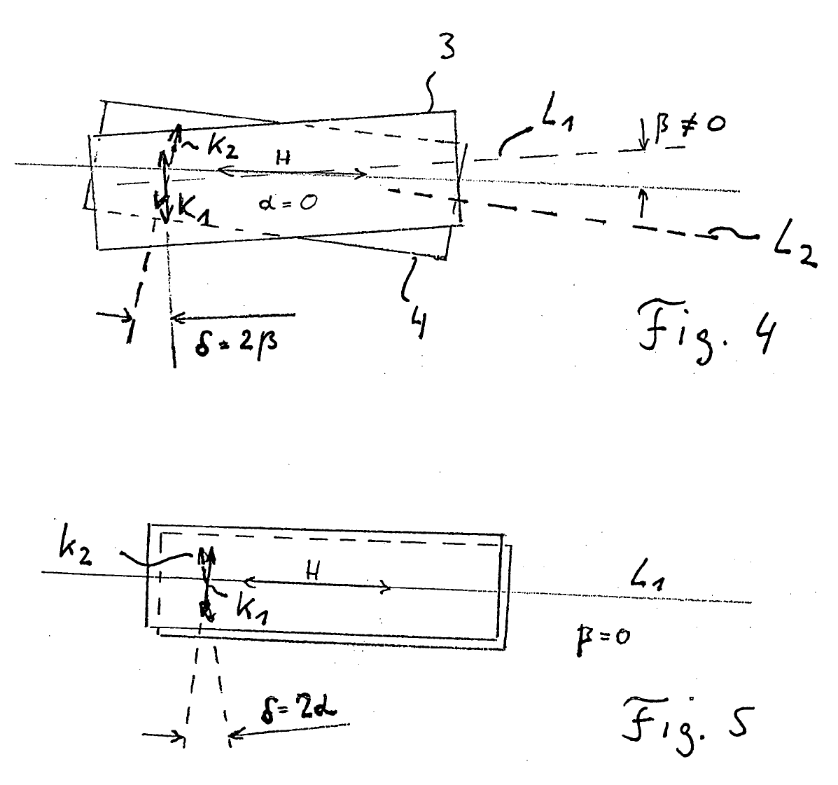

FIG. 3 shows two layers of a magnetic core with the longitudinal axes L parallel to one another but turned by an angle of β>0 with respect to the axis of symmetry H of coil 2. In the illustration, the anisotropic directions k are perpendicular to the longitudinal axes L of the layers.

FIG. 4 shows two layers 3, 4 turned against one another, where the longitudinal axes of the layers are labeled L₁, L₂ and are turned against one another by the angle 2β. β refers to the twist of each individual longitudinal axis L₁, L₂ compared to the cylindrical axis H of the coil. The anisotropic directions k₁, k₂ are each perpendicular to the longitudinal axes L₁, L₂, thus forming an angle of δ=2β.

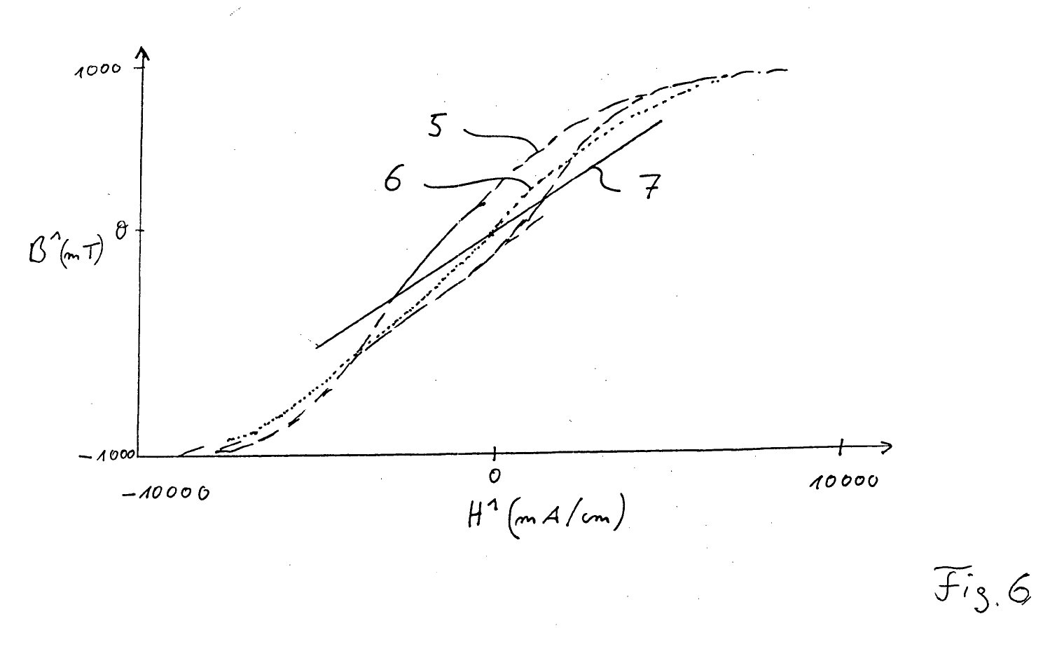

FIG. 5 shows the case of two layers with the longitudinal axes parallel to one another and parallel to the axis of symmetry H of the coil, where each of the anisotropic directions k₁, k₂ is turned by an angle α with respect to the corresponding longitudinal axis. The two layers are designed in such a way that the twist of the anisotropic directions k₁, k₂ are turned in the opposite direction of the angle compared to the corresponding longitudinal axis of the layer, thus resulting in an angle difference between the anisotropic directions k₁, k₂ of δ=2α.

As expected, the analysis of the magnetic properties of the illustrated core constellations initially reveals that the twist of the magnetic core compared to the orientation H of the outer magnetic field with the anisotropic direction k ideally positioned to the longitudinal axis pursuant to FIG. 3 causes the magnetic properties of the overall constellation to deteriorate.

For example, the quality of an antenna comprising a core made of two layers was measured, where the anisotropic direction of both layers was adjusted exactly (δ=0). When both layers are positioned exactly on top of one another and if they are twisted compared to the orientation H of the axis of the coil, the quality of the antenna arrangement decreases as expected.

Surprisingly however it was determined that the quality decreases more if both layers are turned conversely around the angle β compared to the direction H, i.e. if their longitudinal axes L₁, L₂ include the angle δ=2β.

Surprisingly however it was determined as a result that the orientation of the individual longitudinal axes of the layers compared to the orientation H and the one of the angles between the anisotropic directions k₁, k₂ on the one hand and the orientation H or the deviation of this angle of 90° plays a subordinate role. Turning the anisotropic directions against each other has a much greater effect (FIG. 4).

To exclude the influence of the fact that the layers no longer completely overlap in the described constellation illustrated in FIG. 4, the layers were prepared for an additional experiment in such a way that the respective anisotropic directions as illustrated in FIG. 5 are turned each by the angle α or −α compared to the respective longitudinal axis of the layer L₁, L₂.

This way the two layers can be placed congruently on top of one another, where the anisotropic directions k₁, k₂ are turned against each other by the angle α=2δ, similarly to the constellation pursuant to FIG. 4. It was determined, that, consistent with the constellation illustrated in FIG. 4, the quality equally deteriorates strongly. A comparative experiment in which the layers are turned 180° against one another compared to the constellation illustrated in FIG. 5, so that the two anisotropic directions k₁, k₂ were congruent, but turned by the angle α compared to the longitudinal axis of the coil H as shown in FIG. 2, revealed that the quality was far less compromised in this constellation.

Based on the above, it is concluded that the relative position of the anisotropic directions k₁, k₂ of two directly adjacent layers 3, 4 represents the relevant factor with respect to the quality of the overall arrangement.

The described measurements can be conducted under virtually static conditions; therefore, it must be concluded that we are dealing with a magnetostatic as opposed to a dynamic problem.

A possible explanation may be that the residual fields of the individual layers interact with one another. This can be caused by the surface roughness of the layers through which the magnetic fields exit the cross-section and interact with one another. The high overlap of the interfaces of adjacent layers results in a corresponding strong interaction; its range is expected to be a few 10 μm. As shown by a measurement, the greater distance between the layers within the range of 30 to 100 μm leads to a corresponding optimization of the hysteresis loops or the measured qualities.

An additional indicator for the described explanation of the effect is that the conductivity of a spacer inserted between the layers has no effect on the magnetic properties. A synthetic film in this area has an identical effect as a non-magnetic metal film. As a result, no dynamic eddy current effects are involved in the observed effect.

In summary, it was determined that the quality of a core can be determined by the interaction between magnetizations of adjacent layers. Residual fields of the individual layers can interfere with one another, thus displacing the hysteresis loops of the individual layers on the field axis against one another. The result is an increase of the core losses and a reduction of the overall quality of the core.

Current manufacturing procedures do not take into account said interactions; consequently, the magnetization properties of the cores were [subject to] random fluctuations and sub-optimal on average.

Accordingly, the design of a magnetic core according to an embodiment achieves its advantages with the exact as possible parallel orientation of the anisotropic directions k₁, k₂ of the adjacent layers, where the reduction of surface roughness, the optimal space adjustment between adjacent layers and the eddy current-related minimized layer thickness each contribute to the overall quality.

Because the turning of the anisotropic directions k₁, k₂ compared to the longitudinal axes of the layers of the individual layers 3, 4 can not be prevented completely, it should at least be ensured that the turn of the anisotropic directions of adjacent layers compared to the respective longitudinal axis is the same. In a first variant of the manufacturing process this is possible in that the field heat treatment is performed in a stacked core, in which inhomogeneities in the distribution of the anisotropic directions are indeed unavoidable, but where said inhomogeneities are distributed across the whole core pursuant to a constant function and do not skip between two adjacent layers as a result.

However, the various objectives of the invention can be achieved even better with a method in which the layers are first manufactured as a continuous tape, for example by means of rapid solidification technology, followed by continuous corresponding field treatment; as a result the anisotropic direction across the length of the manufactured tape varies as little as possible. The tape is then divided into separate layers and these layers are untwisted to the way they were manufactured as a tape, stacked on top of one another, where it is preferable that the layers which were adjacent before the tape was divided are positioned directly on top of one another on the stack. This procedure ensures that the twisted orientation of the anisotropic directions of adjacent layers compared to their longitudinal axes is not opposite but the same on the one hand and that the amounts of the twist in adjacent layers do not vary too much.

For example, tensile forces in the longitudinal direction of the tape can be applied with a field heat treatment in a continuous operation which contributes to the stabilization of the anisotropic direction diagonal to the longitudinal direction of the tape. The magnetic homogenous tape sections manufactured and separated as described above are then automatically stacked on top of one another as layers and fastened in a suitable manner.

For the tapes treated in said manner, a top side and a bottom side of the tape can be defined, where they differ from the tapes manufactured by means of rapid solidification in that the bottom side which was facing the heat sink during the manufacture, appears matte, while the top side has a shiny appearance. When stacked, the individual layers are arranged in such a way that the top sides of all layers face the same direction.

The individual layers are subsequently fastened against one another by means of gluing, regluing with tape, pouring into a corresponding mould, and overmolding with plastic or a different suitable method. Alternatively, the layers can be equipped with an adhesive layer before or during the stacking process, which fastens the core after being stacked. After completion of the core, it is surrounded with a coil in the form of wire winding, where the axis of the coil is parallel to the longitudinal axis L of the core. The deviation of the direction of the coil axis from the direction L of the longitudinal axis of the core should not exceed several degrees.

While the individual layers are being stacked, it is possible to measure the quality of the resulting core and to optimize the relative position of the individual layers to one another by twisting them. In addition, the magnetic properties of the core can be improved with the insertion of spacers between the individual layers, where the volume increase of the overall core should be limited; consequently, thick spacers are only suitable for cores consisting of relatively few layers.

Generally, the layers which the magnetic core according to an embodiment consists of may also be produced in such a way that the continuously manufactured tape is equipped with anisotropy in its longitudinal axis by means of corresponding field heat treatment, that the tape is subsequently divided into segments and the latter are joined to form a core in such a way that the magnetic anisotropic directions of the individual segments are again perpendicular to the longitudinal axis of the core, as described above. However, in said design, the longitudinal axes of the individual segments would be positioned at a 90° angle to the longitudinal axis of the resulting core.

FIG. 6 shows different hysteresis loops for a core comprising several layers of amorphous cobalt base alloy, where the curves 5, 6, are based on a core manufactured according to a common method. For this purpose, the tape is assembled to a reel and said reel or stack of several reels tempered in a magnetic field. Fluctuations of the anisotropic direction along the length of the tape are unavoidable. The tape is then divided into segments and they are stacked. Magnetic measurements show a twist of the anisotropic directions of adjacent tapes. Curve 7 is based on a core the individual layers of which are equipped with a uniform anisotropic direction before being stacked, which is almost perpendicular (α<4°) to the longitudinal axis. The measurements of two cylindrical coils are recorded at a frequency of 3 kHz.

Curve 5 shows a standard hysteresis loop where the individual layers of the core are stacked directly on top of one another. In this case, the direct contact of the tape layers and the corresponding scattering of the anisotropic directions result in an increase of the residual and coercive field strength.

Curve 6 develops if spacers in the form of a 30 μm film are placed between the individual layers with identical manufacture of the individual layers. It is observed that the mutual interaction between the layers is practically eliminated as a result of the inserted film; the area of the hysteresis loop is minimized due to the low retentivity and reduction of the coercive field strength. However, the size of the linearity range of the corresponding curve 6 is not yet optimal due to deviations in the individual anisotropic directions of the layers.

Almost no area is visible in the hysteresis loop in curve 7 anymore; moreover it shows an optimal linearity range in that relatively small deviations between the anisotropic directions of the individual layers are achieved with the manufacturing process. In both cases, curve 7 is achieved almost identically in that spacers in the form of a 30 μm film are inserted between the layers on the one hand or that they are omitted on the other hand. This shows that with the sufficiently exact correspondence of the anisotropic directions the interaction between the individual layers is equally minimized without the insertion of a film.

What is claimed is:

1. A magnetic core comprising at least two layers of a magnetic material, wherein each layer comprises a separate longitudinal axis of the layer as well as a preferred magnetic orientation (anisotropic direction) which is at least almost perpendicular to the longitudinal axis of the layer, and wherein
the different layers are oriented in such a way that the angles between the anisotropic direction of directly adjacent layers are as small as possible, irrespective of the orientation of the longitudinal axes of the layers.

2. The magnetic core according to claim 1, wherein
the angles between the anisotropic directions of adjacent layers are smaller than 10°.

3. The magnetic core according to claim 2, wherein the angle is smaller than 4°.

4. The magnetic core according to claim 1, wherein
the individual layers with respect to their position during the manufacturing step during which the preferred magnetic orientation is created, are positioned on top of one another untwisted.

5. The magnetic core according to claim 1, wherein
the layers are manufactured by means of rapid solidification technology and that, if the side facing the heat sink is referred to as bottom side and the opposite site is referred to as top side, the top side of each layer is adjacent to the bottom side of the respective adjacent layer.

6. The magnetic core according to claim 1, wherein
the roughness of the layers in the place where several layers touch one another is less than 0.5 μm.

7. The magnetic core according to claim 5, wherein
the roughness of the layers is less than 0.3 μm.

8. The magnetic core according to claim 1, wherein
the distance between adjacent layers is less than 20 μm.

9. The magnetic core according to claim 8, wherein the distance between adjacent layers is less than 10 μm.

10. The magnetic core according to claim 1, wherein the layers consist of a material with a relative permeability between 500 and 20,000.

11. The magnetic core according to claim 10, wherein the relative permeability is between 1,000 and 10,000.

12. The magnetic core according to claim 1, wherein the quality is greater than 20 with a frequency of 125 kHz.

13. The magnetic core according to claim 1, wherein the layers consist of an amorphous or nanocrystalline magnetic material.

14. The magnetic core according to claim 1, wherein the adjacent layers are separated by intermediate layers made of non-magnetic and/or electrically isolating material.

15. A magnetic arrangement comprising a magnetic core comprising at least two layers of a magnetic material, wherein each layer comprises a separate longitudinal axis of the layer as well as a preferred magnetic orientation (anisotropic direction) which is at least almost perpendicular to the longitudinal axis of the layer, wherein
the different layers are oriented in such a way that the angles between the anisotropic direction of directly adjacent layers are as small as possible, irrespective of the orientation of the longitudinal axes of the layers,
comprising a coil surrounding the magnetic core, wherein
the coil is essentially parallel to a longitudinal axis of the magnetic core, and wherein the longitudinal axis is determined by averaging the individual longitudinal axes of the layers.

16. A method for the manufacture of a magnetic core, the method comprising the step of:
during the manufacturing process of individual layers of a magnetic material, wherein each layer comprises a separate longitudinal axis of the layer as well as a preferred magnetic orientation (anisotropic direction) which is at least almost perpendicular to the longitudinal axis of the layer, and wherein the different layers are oriented in such a way that the angles between the anisotropic direction of directly adjacent layers are as small as possible, irrespective of the orientation of the longitudinal axes of the layers, their position is recorded relative to one another and is taken into account when they are stacked in such a way that the individual layers are stacked untwisted compared to their position relative to one another drug during the manufacturing process.

17. A method for the manufacture of a magnetic core of a magnetic material, wherein each layer comprises a separate longitudinal axis of the layer as well as a preferred magnetic orientation (anistropic direction) which is at least almost perpendicular to the longitudinal axis of the layer, and wherein the different layers are oriented in such a way that the angles between the anisotropic direction of directly adjacent layers are as small as possible, irrespective of the orientation of the longitudinal axes of the layers the method comprising the step of:
the preferred magnetic orientations of adjacent layers are oriented parallel to one another as much as possible while the layers are stacked and that individual or several of the layers are subsequently trimmed in such a way that a massive stack develops.

18. A method for the manufacture of a magnetic core according to claim 16, wherein
the individual layers are manufactured as segments of a continuously produced tape which is equipped with a preferred magnetic orientation and then divided.

19. The method according to claim 16, wherein
the layers are first manufactured and the preferred magnetic orientation is applied when they are stacked.

20. The method according to claim 16, wherein
the preferred magnetic orientation is adjusted by means of heat treatment in a magnetic field.

21. The method according to claim 16, wherein
a mechanical tensile force is applied perpendicular to the preferred magnetic orientation within the scope of the generation of the latter.

22. The method according to claim 18, in which an anisotropy is adjusted essentially perpendicular to the running direction of the tape.

23. The method according to claim 18 in which an anisotropy is adjusted essentially perpendicular to the running direction of the tape.

24. The method according to claim 17, wherein the layers are first manufactured and the preferred magnetic orientation is applied when they are stacked.

25. The method according to claim 17, wherein the preferred magnetic orientation is adjusted by means of heat treatment in a magnetic field.

26. The method according to claim 17, wherein a mechanical tensile force is applied perpendicular to the preferred magnetic orientation within the scope of the generation of the latter.

27. The method according to claim 18, wherein the preferred magnetic orientation is adjusted by means of heat treatment in a magnetic field.

28. The method according to claim 18, wherein a mechanical tensile force is applied perpendicular to the preferred magnetic orientation within the scope of the generation of the latter.
